(19) United States
(12) Patent Application Publication
(10) Pub. No.: US 2026/0359578 A1
(43) Pub. Date: Nov. 12, 2026

(54) SYSTEM FOR OPTIMIZING LANGUAGE OUTPUTS THROUGH MULTI-AGENT OVERSIGHT NETWORKS

(71) Applicant: International Business Machines Corporation, Armonk, NY (US)

(72) Inventor: Bo WEN, Chappaqua, NY (US)

(21) Appl. No.: 19/201,464

(22) Filed: May 7, 2025

(51) Int. Cl. G06F 40/40; G06F 40/35; G06N 20/20

(52) U.S. Cl. CPC G06F 40/40; G06F 40/35; G06N 20/20

(57) ABSTRACT

In some implementations, a chat system may receive an input associated with a chatbot. The chat system may generate a chatbot response. The chat system may evaluate, using a first layer of an ensemble of judge agents, the chatbot response. The chat system may measure a consensus among the evaluations using a differentiator. The chat system may resolve one or more low consensus cases among the evaluations using a second layer of super judge agents. The chat system may determine a final evaluation of the chatbot response based on a consensus technique applied to the evaluations. The chat system may transmit information associated with the final evaluation of the chatbot response. The chat system may fine-tune, by the chat system, one or more parameters of the ensemble of judge agents based on determinations made by the super judge agents.

### BACKGROUND

This disclosure relates to chat systems, and more specifically, to a system for optimizing language outputs through multi-agent oversight networks.

### SUMMARY

Some aspects described herein relate to a method. The method may include receiving, by a chat system, an input associated with a chatbot. The method may include generating, by the chat system, a chatbot response. The method may include evaluating, by the chat system and using a first layer of an ensemble of judge agents, the chatbot response. The method may include measuring, by the chat system, a consensus among the evaluations of the ensemble of judge agents using a differentiator. The method may include resolving, by the chat system, one or more low consensus cases among the evaluations using a second layer of super judge agents. The method may include determining, by the chat system, a final evaluation of the chatbot response based on a consensus technique applied to the evaluations provided by the ensemble of judge agents and the super judge agents. The method may include transmitting, by the chat system, information associated with the final evaluation of the chatbot response. The method may include fine-tuning, by the chat system, one or more parameters of the ensemble of judge agents based on determinations made by the super judge agents.

Some aspects described herein relate to a computer system. The computer system may include a processor set, one or more computer-readable storage media, and program instructions stored on the one or more computer-readable storage media to cause the processor set to perform operations. The operations may include evaluating chatbot responses using a first layer of an ensemble of judge agents powered by a plurality of types of large language models. The operations may include measuring consensus among judge agent assessments using a differentiator. The operations may include resolving low consensus cases with a second layer of super judge agents. The operations may include determining a final evaluation of the chatbot response based on a consensus mechanism applied to judge agent assessments. The operations may include fine-tuning the ensemble of judge agents based on super judge determinations and a set of configured tuning criteria.

Some aspects described herein relate to a computer program product. The computer program product may include one or more computer-readable storage media and program instructions stored on the one or more computer-readable storage media to perform operations. The operations may include assessing, by a multi-layer architecture of judge agents of a system, a chatbot response to evaluate the performance of the chatbot. The operations may include determining, by a differentiator of the system, a level of consensus among assessments from a first layer of judge agents in the multi-layer architecture. The operations may include resolving, by a second layer of super judge agents in the multi-layer architecture of the system, low consensus cases from the first layer of judge agents. The operations may include determining, by a consensus mechanism of the system, a final evaluation based on assessments from the second layer of super judge agents. The operations may include fine-tuning, by a compliance improvement module of the system, specific judge agents based on determinations from the second layer of super judge agents and compliance criteria.

### BRIEF DESCRIPTION OF THE DRAWINGS

FIG. 1 is a diagram of an example computing environment for system for optimizing language outputs through multi-agent oversight networks described herein.

FIGS. 2A-2D are diagrams of an example implementation associated with a system for optimizing language outputs through multi-agent oversight networks.

FIG. 3 is a diagram of example components of a device associated with a system for optimizing language outputs through multi-agent oversight networks.

FIG. 4 is a flowchart of an example process associated with a system for optimizing language outputs through multi-agent oversight networks.

### DETAILED DESCRIPTION

The following detailed description of example implementations refers to the accompanying drawings. The same reference numbers in different drawings may identify the same or similar elements.

The accuracy and reliability of large language models (LLMs) in chatbots has become a growing concern, especially in high-stakes applications, such as healthcare. The generation of unsubstantiated or incorrect content, sometimes referred to as “LLM hallucinations,” can result in issues for users seeking information, such as medical advice, from an LLM. In another example, when performing code review, some LLMs may generate code that references non-existent packages or tools, thereby resulting in errors in code execution. In another example, when performing a semiconductor layout design task, some LLMS may generate instructions that, while facially accurate, result in fabrication-incompatible designs or incorrect topology. The evaluation of LLM performance in chatbots may use automated assessments and benchmarks. However, some techniques are limited in an ability to directly assess incorrect content generation, diagnostic reasoning, or bias. An alternative to automated assessment is expert human review. Expert human review is time-consuming, expensive, and difficult to scale to meet an increasing demand for trustworthy chatbots. Moreover, the human-centric evaluation process may be static, failing to account for the evolving nature of LLM capabilities, and may lack the adaptability to align with changing stakeholder guidelines and concerns.

The lack of effective, efficient, and scalable evaluation technologies hinders the widespread adoption of reliable and trustworthy chatbots in healthcare and other critical domains. Addressing these technical challenges is crucial for realizing the full potential of LLMs in chatbots, ensuring chatbot utilization safety, and enhancing chatbot utility through improved accuracy, reduced bias, and alignment with stakeholder needs.

Some implementations described herein provide a system for evaluating the performance of chatbots, particularly in detecting hallucinations and ensuring accuracy. For example, a system may receive an input associated with a chatbot, generate a chatbot response, and evaluate the response using a first layer of an ensemble of judge agents. The system may measure a consensus among the evaluations of the ensemble of judge agents using a differentiator, resolve one or more low consensus cases among the evaluations using a second layer of super judge agents, and determine a final evaluation of the chatbot response based on a consensus technique applied to the evaluations provided by the ensemble of judge agents and the super judge agents.

In some aspects, the ensemble of judge agents may be powered by a plurality of sets of LLMs, and the differentiator may measure consensus by comparing a variance of judge agent evaluations with respect to a configured threshold. The second layer of super judge agents may utilize pairwise comparisons of judge agent evaluations to resolve the one or more low consensus cases, and the consensus technique may apply a weighted voting scheme to judge agent evaluations. The system may also fine-tune the ensemble of judge agents using reinforcement learning techniques to align a performance with a set of configured criteria. Although some implementations are described herein in terms of chatbots, it is contemplated that implementations described herein may be applicable to other generative systems providing other generative model outputs.

In this way, the system provides a multi-agent architecture for evaluating chatbot performance, enabling the detection of hallucinations and ensuring accuracy in high-stakes applications. By leveraging the differential configuration or training data sets of multiple judge agents and employing consensus mechanisms, the system may optimize the detection of anomalies in chatbot outputs, thereby reducing false positives and false negatives, and improving the overall efficiency of chatbot performance evaluation. In this way, the system may conserve processing resources, memory resources, network resources, and/or the like.

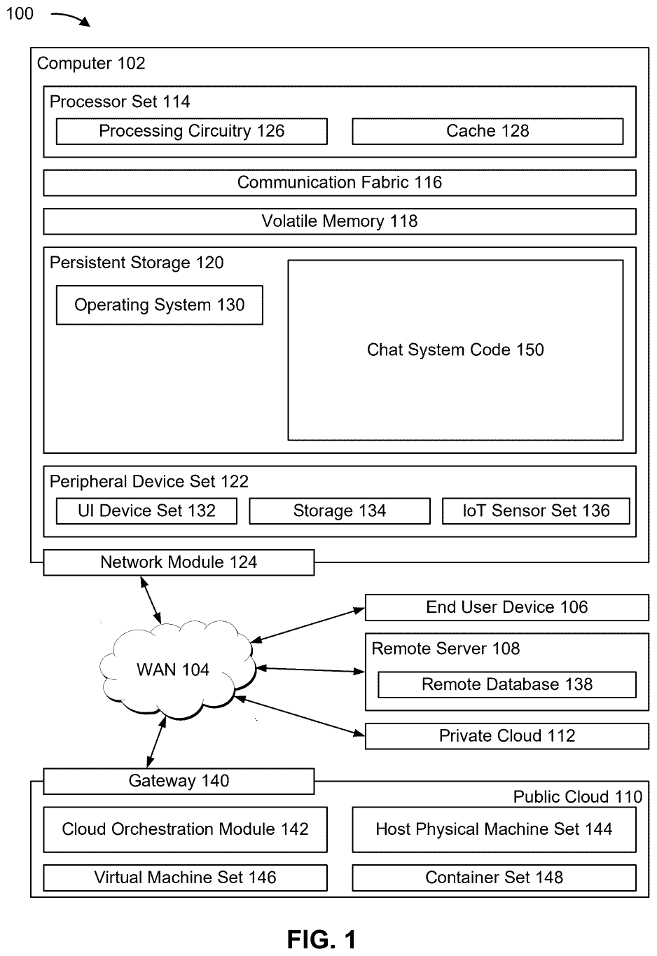

FIG. 1 is a diagram of an example computing environment 100 for system for optimizing language outputs through multi-agent oversight networks described herein.

The computing environment 100 contains an example of an environment for the execution of at least some of the computer code involved in performing the inventive methods, such as chat system code 150. In addition to the chat system code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the chat system code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 126 may be distributed over multiple packages, for example, multiple, coordinated integrated circuit chips. The processing circuitry 126 may implement multiple processor threads and/or multiple processor cores. The cache 128 is memory that is located in the processor chip package(s) and is typically used for data or code that should be available for rapid access by the threads or cores running on the processor set 114. Cache memories are typically organized into multiple levels depending upon relative proximity to the processing circuitry. Alternatively, some, or all, of the cache for the processor set may be located “off chip.” In some computing environments, the processor set 114 may be designed for working with qubits and performing quantum computing. Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in the chat system code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read only memory (ROM), but typically at least a portion of the persistent storage allows writing of data, deletion of data and re-writing of data. Some familiar forms of persistent storage include magnetic disks and solid state storage devices. The operating system 130 may take several forms, such as various known proprietary operating systems or open source Portable Operating System Interface-type operating systems that employ a kernel. The code included in the chat system code 150 typically includes at least some of the computer code involved in performing one or more operations described herein.

In some implementations, the operations may include receiving an input associated with a chatbot; generating a chatbot response; evaluate, using a first layer of an ensemble of judge agents, the chatbot response; measuring a consensus among the evaluations of the ensemble of judge agents using a differentiator; resolving one or more low consensus cases among the evaluations using a second layer of super judge agents; determining a final evaluation of the chatbot response based on a consensus technique applied to the evaluations provided by the ensemble of judge agents and the super judge agents; transmitting information associated with the final evaluation of the chatbot response; and fine-tuning, by the chat system, one or more parameters of the ensemble of judge agents based on determinations made by the super judge agents. In some implementations, the operations may include evaluating chatbot responses using a first layer of an ensemble of judge agents powered by a plurality of types of large language models; measuring consensus among judge agent assessments using a differentiator; resolving low consensus cases with a second layer of super judge agents; determining a final evaluation of the chatbot response based on a consensus mechanism applied to judge agent assessments; and fine-tuning the ensemble of judge agents based on super judge determinations and a set of configured tuning criteria. In some implementations, the operations may include assessing a chatbot response to evaluate the performance of the chatbot; determining a level of consensus among assessments from a first layer of judge agents in the multi-layer architecture; resolving low consensus cases from the first layer of judge agents; determining a final evaluation based on assessments from the second layer of super judge agents; and fine-tuning, by a compliance improvement module of the system, specific judge agents based on determinations from the second layer of super judge agents and compliance criteria.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

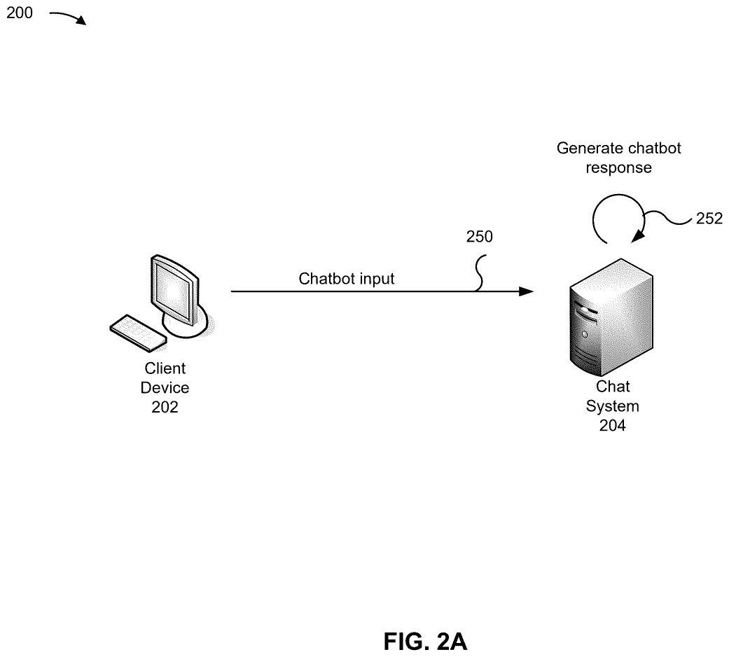

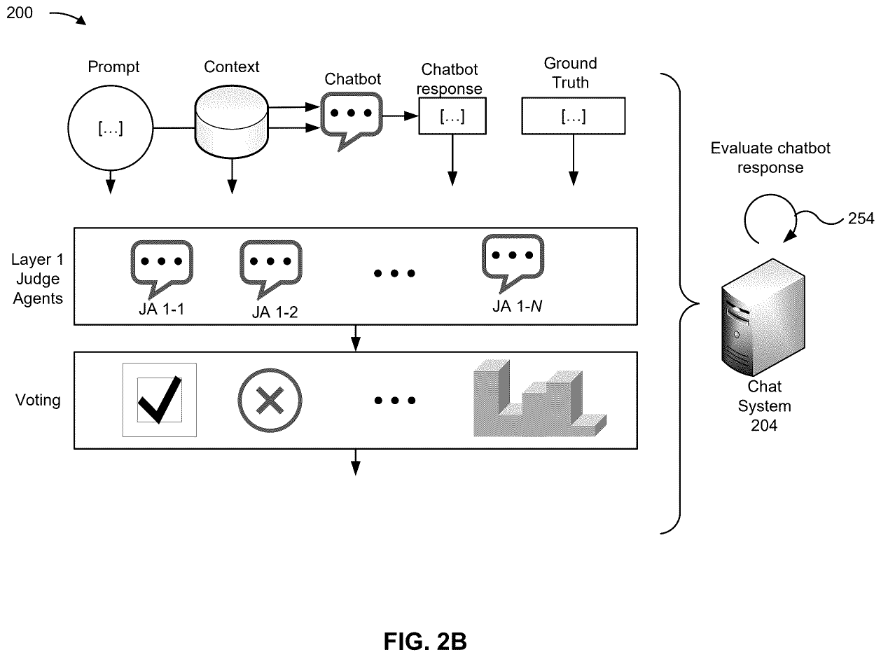

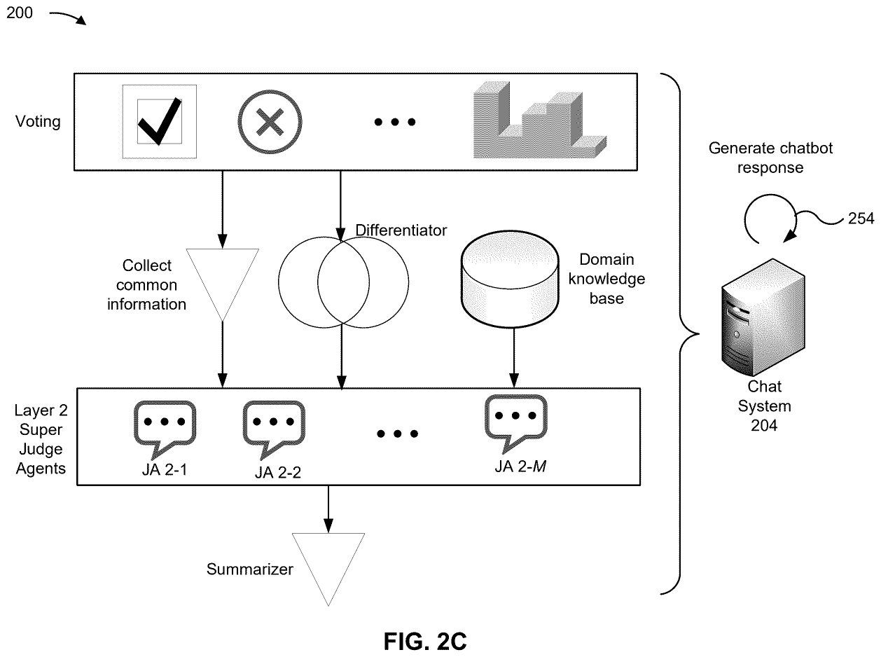

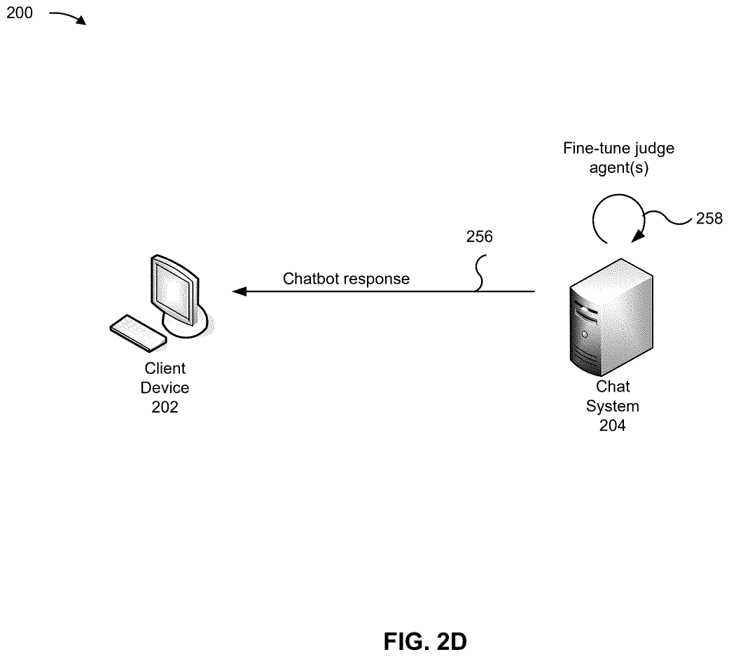

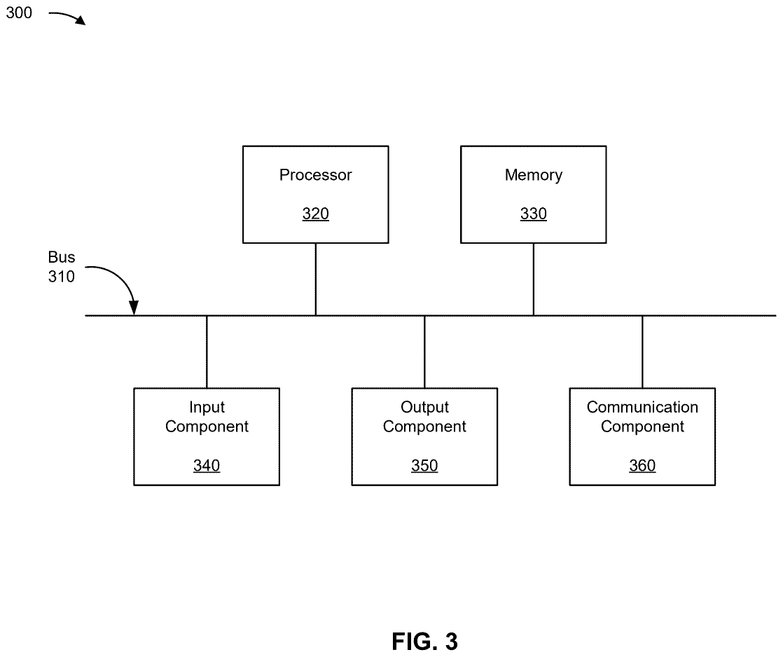

FIGS. 2A-2D are diagrams of an example implementation 200 associated with a system for optimizing language outputs through multi-agent oversight networks. As shown in FIGS. 2A-2D, example implementation 200 includes a client device 202 and a chat system 204. These devices are described in more detail below in connection with FIG. 1 and FIG. 3. In some implementations, the chat system 204 may correspond to the computer 102 of the FIG. 1. In some implementations, rather than a chat system 204 providing a chatbot response, another type of generative system may provide another type of response or output for evaluation, as described herein.

As shown by FIG. 2A, and by reference number 250, the client device 202 may transmit an input associated with a chatbot to the chat system 204. For example, the client device 202 may send a message to the chat system 204, which may be associated with a specific chatbot. The chat system 204 may receive the input and generate a chatbot response, as shown by reference number 252. The chatbot response may then be evaluated by the chat system 204 using a first layer of an ensemble of judge agents, as described in more detail herein. In some implementations, the chatbot input and/or the chatbot response may include a textual input or a textual response. Additionally, or alternatively, the chatbot input and/or the chatbot response may include audio information, image information, video information, or another type of information.

As shown in FIG. 2B, and by reference number 254, the chat system 204 may evaluate the chatbot response. For example, the chat system 204 may feed in a set of inputs to a chatbot evaluation component. In this case, the inputs to the chatbot evaluation component may include a prompt (e.g., an input associated with triggering the chatbot response), a context, a chatbot response (e.g., the chatbot response generated for the prompt), or a ground truth, among other examples. In some implementations, the context may include information identifying a specific scenario, topic, or set of circumstances that defines a scope and relevance of a user's input or prompt, and informs the chatbot's response or action. For example, in a medical diagnostics chatbot scenario, a context may include information indicating that the chatbot is being used for a medical diagnosis, a customer service inquiry, or a language translation request, among other examples. In a code generation or code review chatbot scenario, a context may include information indicating a system in which the code is to be executed, a language for the code, a set of packages or environments with which the code is to interact, or a set of constraints for the code generation or code review. In a semiconductor layout scenario, a context might include information identifying a type of circuit, a process design kit, a set of design rules or constraints, or a set of electrical constraints, among other examples. In some implementations, the ground truth may include objective, accurate, or authoritative information or data that serves as a reference point or criterion for measuring a chatbot output. For example, the ground truth may include information identifying a doctor's diagnosis or an expert's evaluation.

In some implementations, the chat system 204 may evaluate the chatbot response using a first layer of judge agents. For example, the chat system 204 may have layer-1 judge agents JA 1-1 through JA 1-N generate respective evaluations of the chatbot response using the prompt, context, chatbot response, or ground truth, among other data. In some implementations, each layer-1 judge agent may be trained on a specific dataset or set of criteria to evaluate the chatbot response from a particular perspective or dimension. For example, each layer-1 judge agent may use a different LLM model, be trained with a different dataset, or have a different context for how to evaluate or what criteria to use to evaluate the chatbot response, among other examples. In this case, a layer-1 judge agent JA 1-1 may be trained to evaluate the chatbot response for clinical accuracy, while a layer-1 judge agent JA 1-2 may be trained to evaluate the chatbot response for potential safety issues. Similarly, a layer-1 judge agent JA 1-3 may be trained to evaluate the chatbot response for consistency with medical guidelines (or code optimization guidelines or semiconductor layout guidelines), and a layer-1 judge agent JA 1-4 may be trained to evaluate the chatbot response for linguistic clarity and coherence.

The judge agents in the first layer of the ensemble may be trained using a dataset of labeled chatbot responses, where each label indicates the accuracy and relevance of the response. The training process may include optimizing the parameters of each judge agent using a supervised learning algorithm, such as stochastic gradient descent. In some implementations, the judge agents (e.g., the first layer of judge agents or the second layer of judge agents, as described in more detail herein) may be trained using a dataset that includes a range of examples of chatbot responses, associated prompts, context, ground truth, or other relevant information. Such a dataset may be curated to ensure that the dataset is representative of real-world scenarios and that the dataset includes a range of examples of accurate and inaccurate chatbot responses. The chat system 204 may train the judge agents (or may access judge agents that have been trained) using a supervised learning approach, where the training data is labeled with a correct evaluation for each chatbot response. Such a training process may involves optimizing the parameters of each judge agent using a stale gradient descent algorithm with a mini-batch size, in which the algorithm has a configured decay or learning rate parameter and a configured batch size parameter. In some implementations, the ensemble of judge agents may include at least one LLM judge agent or at least one rule-based analysis algorithm judge agent, among other examples. An LLM judge agent may use probability-based methods to analyze the chatbot response. In contrast, a rule-based analysis algorithm judge agent may use deterministic rules to evaluate the response. A combination of these different types of judge agents may cause the chat system 204 to provide a more comprehensive evaluation of the chatbot response.

In some implementations, in evaluating the chatbot response, each layer-1 judge agent may use the prompt, context, chatbot response, and ground truth as input, and may apply one or more evaluation metrics or algorithms to generate a score or rating that is indicative of the chatbot response's quality or accuracy. For example, a layer-1 judge agent JA 1-1 may apply a semantic similarity metric to evaluate the chatbot response's semantic alignment with the ground truth. Similarly, a layer-1 judge agent JA 1-2 may apply a risk assessment algorithm to evaluate the chatbot response's potential safety risks.

In some implementations, evaluations generated by each layer-1 judge agent may be represented using a particular data type. For example, the chat system 204 may generate, using the layer-1 judge agents, evaluations that include a set of numerical scores, categorical labels, or text-based feedback, among other examples. The evaluations may be stored in a database or other data structure within the chat system 204, and may be used as input to subsequent layers of judge agents or other components within the chat system 204, as described in more detail herein. In some implementations, the chat system 204 may generate a set of evaluations that represent a set of votes regarding whether a chatbot response satisfies one or more criteria.

In some implementations, the ensemble of judge agents (e.g., the layer-1 judge agents) (or another set of judge agents, such as the super judge agents, as described herein) may include an odd quantity of judge agents. For example, the ensemble of judge agents may include 3, 5, 7, 9, 11, or another odd quantity of judge agents, to avoid ties in the evaluations of the ensemble of judge agents. In some implementations, different mechanisms may be used to ensure that judge agents evaluate a chatbot response in different manners. For example, the ensemble of judge agents may include judge agents associated with different LLM vendors, judge agents using different temperature settings or seed variation settings, or judge agents using different model architectures, among other examples.

In some implementations, as shown in FIG. 2C, the chat system 204 may use one or more techniques to collect common information from a result of the layer-1 judge agents evaluating the chatbot response. The chat system 204 may combine or aggregate the evaluations generated by the layer-1 judge agents. For example, the chat system 204 may use a weighted voting algorithm to combine the scores generated by each layer-1 judge agent. Additionally, or alternatively, the chat system 204 may use a machine learning model to integrate the evaluations generated by multiple layer-1 judge agents. In other words, the chat system 204 may use the evaluations as input to a trained machine learning model that generates, as an output, a combined evaluation. The chat system 204 may use the combined evaluation may be used to generate an overall assessment of the chatbot response's quality or accuracy.

In some implementations, as shown in FIG. 2C, the chat system 204 may measure consensus among the evaluations of the ensemble of judge agents using a differentiator. For example, the chat system 204 may use the differentiator to compare a variance of judge agent evaluations with respect to a configured threshold to determine the level of consensus. In some implementations, the differentiator may include a software module or process that is configured to receive as input the evaluations generated by the ensemble of judge agents and to output a measurement of consensus among the evaluations. For example, to measure consensus, the chat system 204 may use the differentiator to apply a variety of techniques, such as calculating a variance of the judge agent evaluations. In this approach, the chat system 204 may use the differentiator to compute a mean of the evaluations and then calculate a variance of the evaluations with respect to the mean. The differentiator may be configured to measure consensus by comparing the variance of the judge agent evaluations with respect to a threshold, which may be determined experimentally or through simulation. In some implementations, the chat system 204 may implement the differentiator using a machine learning model, such as a neural network or a decision tree. A neural network may be trained on a dataset that includes examples of chatbot responses that have been evaluated by the judge agents, and corresponding labels that indicate a level of consensus among the evaluations. A machine learning model can be selected based on an accuracy or robustness, and may be tuned using hyperparameter optimization techniques to perform well for specific types of chatbot responses and evaluation metrics. In some implementations, the differentiator applies a threshold-based approach to determine the level of consensus among the evaluations.

In some implementations, the differentiator can measure consensus among the assessments from the first layer of judge agents by analyzing the semantic similarity in the first layer of judge agents'respective reasoning traces. Semantic similarity can include a degree to which reasoning processes and conclusions of the judge agents align in meaning and context (e.g., rather than merely matching in surface-level content). The differentiator use natural language processing techniques to compare the detailed reasoning steps provided by each judge agent, identifying common elements and areas of divergence. By focusing on the underlying semantics of the reasoning traces, the differentiator can more accurately determine the reliability and validity of the assessments, ensuring that the final evaluation is based on a robust and meaningful consensus. This approach enhances the system's ability to detect nuanced differences in judgment and provides a more comprehensive evaluation of a chatbot response or another type of generative response or output.

The variance may be calculated using a variance formula or a variance determination algorithm. The chat system 204 may use the differentiator to compare the calculated variance to a configured threshold to determine a level of consensus. In some implementations, the threshold may be set based on a set of configured criteria, and may be adjusted based on the specific requirements of the chat system 204. For example, if the variance is below a threshold of a first value, the chat system 204 may determine that there is a high level of consensus for the evaluations. In contrast, if the variance is above the threshold of the first value, the chat system 204 may determine that there is a low level of consensus for the evaluations.

In some implementations, the chat system 204 may use a machine learning model to analyze the evaluations and determine the level of consensus. For example, the chat system 204 may use a clustering algorithm to group the evaluations into clusters based on respective similarity scores, and then calculate a variance within each cluster. In some implementations, an output of the differentiator may be a binary value indicating whether the level of consensus is high or low, or a continuous value representing a degree of consensus. The output may be used by the chat system 204 to determine one or more further evaluations, such as whether to invoke a second layer of judge agents or whether to generate a final evaluation of the chatbot response. For example, in a case where the level of consensus is low, the chat system 204 may invoke a second layer of judge agents to further evaluate the chatbot response. The second layer of judge agents may include more advanced or specialized judge agents, than are used for the first layer of judge agents, that are capable of resolving a lack of consensus among the first layer of judge agents. In contrast, in a case where the level of consensus is high, the chat system 204 may generate a final evaluation of the chatbot response based on the evaluations of the ensemble of first layer judge agents. In this case, the final evaluation may be used to provide feedback to the chatbot or to determine the accuracy of the chatbot response. The second layer of super judge agents may be trained using a dataset of chatbot responses that have been evaluated by the first layer of judge agents. The super judge agents may be trained to predict the final evaluation of the chatbot response based on the evaluations provided by the first layer of judge agents.

As further shown in FIG. 2C, the chat system 204 may use a second layer of super judge agents to resolve one or more low consensus cases among the evaluations. The second layer of super judge agents may include more advanced or specialized judges, compared with the first layer of judge agents, that are capable of resolving the disagreements among the first layer of judge agents. The super judge agents may be trained on a specific dataset or set of criteria that enable the super judge agents to evaluate the chatbot response from a particular perspective or dimension. For example, the second layer of super judge agents may be trained to analyze the common and different elements of the evaluations generated by the first layer of judge agents. In this case, the second layer of super judge agents may aggregate information to select or generate a best output. In some implementations, the super judge agents may use pairwise comparisons to resolve conflicts and generate a final evaluation.

In some implementations, the super judge agents and the judge agents may implement a convolutional neural network (CNN) like architecture in which each layer of judges extracts and analyzes progressively-higher level features from information. For example, when evaluating code, the first layer judge agents may identify a set of specific code issues, such as syntax errors, variable naming errors, or logical flow errors. In contrast, second layer judge agents (e.g., the super judge agents) may analyze patterns across the findings of the first layer judge agents to identify common types of errors or common contradictions. Accordingly, higher layer judge agents can extract abstract concepts, such as architectural decisions or design patterns, that result in errors propagating throughout a chatbot response. Accordingly, by using a hierarchical analysis, the chat system 204 can generate evaluations that exceed a quality or scope of any individual judge agent's assessment.

In some implementations, the super judge agents may use additional information, such as expert knowledge specific to a domain (e.g., a medical domain, a code generation domain, or a semiconductor layout domain, among other examples), to generate one or more evaluations. In this case, the chat system 204 may access a medical knowledge base (or a code generation knowledge base or semiconductor layout knowledge base) or database that stores domain-specific information or guidelines, among other examples. In some implementations, the chat system 204 integrates domain-specific knowledge bases using a retrieval-augmented generation (RAG) or a knowledge infusion technique. The RAG technique retrieves relevant information from a knowledge base and uses the information to generate responses. The knowledge infusion technique embeds domain-specific information into the judge agents'reasoning processes.

In some implementations, he second layer of super judge agents may be invoked when a level of consensus among evaluations of the first layer of judge agents is low. The chat system 204 may determine that the consensus level is low using the differentiator, which measures consensus among the evaluations and outputs a measurement of consensus, as described above. The chat system 204 may use a summarizer component to aggregate results from the second layer of super judge agents to generate a final report or fine-tuning, as described in more details herein. Although some implementations are described in terms of two layers of judge agents, other quantities of hierarchical layers of judge agents may be possible. For example, a third layer of super judge agents may be used to resolve consensus issues among the second layer of super judge agents.

As shown in FIG. 2D, and by reference numbers 256 and 258, the chat system 204 may output a chatbot response and/or fine-tune one or more judge agents based on evaluating the initial chatbot response. In some implementations, the chat system 204 may output, to the client device 202, a chatbot response that has been evaluated and validated by the ensemble of first layer judge agents and the second layer of super judge agents. In this case, the output may include a text-based response, a dialogue box, or another type of response associated with a chat interface.

In some implementations, the chat system 204 may fine-tune one or more judge agents based on evaluations generated by the ensemble of first layer of judge agents and the second layer of super judge agents. For example, the chat system 204 may adjust one or more parameters of the judge agents (e.g., the first layer of judge agents or the second layer of super judge agents, among other examples), such as by adjusting a set of weights, biases, or activation functions, to improve performance and accuracy. In some implementations, the chat system 204 may use a compliance improvement module to fine-tune the judge agents based on the evaluations generated by the super judge agents. The compliance improvement module may be implemented as a software module or process that is configured to adjust the parameters of the judge agents to improve alignment with stakeholder guidelines and requirements. The compliance improvement module may be implemented using a reinforcement learning algorithm, such as Q-learning, which adjusts the parameters of the judge agents based on the determinations made by the super judge agents and the compliance criteria. In some implementations, the compliance improvement module uses a reward signal based on the performance of the judge agents on a validation dataset to update the weights of the agents, and also uses knowledge distillation to transfer knowledge from the super judge agents to the first layer judge agents.

In some implementations, an output of the chat system 204 may include a final evaluation of the chatbot response, which may be used to provide feedback to the chatbot or to determine an accuracy of the chatbot response. The chat system 204 may generate the final evaluation based on a consensus mechanism that takes into account the evaluations generated by the super judge agents, and may be used to improve the performance and accuracy of the chat system 204. The consensus mechanism may be implemented using a weighted voting scheme, where the weights are determined based on the performance of each judge agent on a validation dataset.

In some implementations, the fine-tuning of the judge agents may include using a reinforcement learning technique to align performance with stakeholder requirements or configured criteria. For example, the chat system 204 may use the reinforcement learning technique to adjust the parameters of the judge agents to optimize performance and accuracy. In some implementations, the fine-tuning of the judge agents may be performed continuously. For example, the chat system 204 may adjust the parameters of the judge agents in real-time based on the evaluations generated by the super judge agents. This may enable the chat system 204 to adapt to changing stakeholder requirements or performance criteria and to improve performance and accuracy over time.

As indicated above, FIGS. 2A-2D are provided as an example. Other examples may differ from what is described with regard to FIGS. 2A-2D. The number and arrangement of devices shown in FIGS. 2A-2D are provided as an example. In practice, there may be additional devices, fewer devices, different devices, or differently arranged devices than those shown in FIGS. 2A-2D. Furthermore, two or more devices shown in FIGS. 2A-2D may be implemented within a single device, or a single device shown in FIGS. 2A-2D may be implemented as multiple, distributed devices. Additionally, or alternatively, a set of devices (e.g., one or more devices) shown in FIGS. 2A-2D may perform one or more functions described as being performed by another set of devices shown in FIGS. 2A-2D.

FIG. 3 is a diagram of example components of a device 300 associated with a system for optimizing language outputs through multi-agent oversight networks. The device 300 corresponds to one or more of the client device 202 or the chat system 204. In some implementations, the client device 202 or the chat system 204 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as RAM, ROM, a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

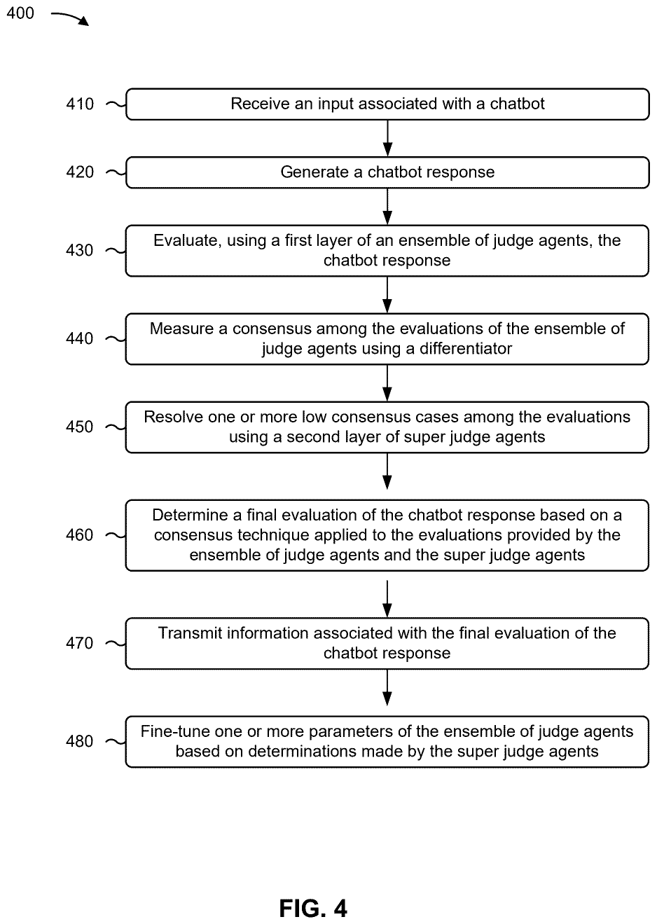

FIG. 4 is a flowchart of an example process 400 associated with a system for optimizing language outputs through multi-agent oversight networks. One or more process blocks of FIG. 4 are performed by a chat system (e.g., the computer 102 or the chat system 204) and/or by another device or a group of devices separate from or including the chat system, such as the client device 202. Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving an input associated with a chatbot (block 410). For example, the chat system may receive an input associated with a chatbot, as described above.

As further shown in FIG. 4, process 400 includes generating a chatbot response (block 420). For example, the chat system may generate a chatbot response, as described above.

As further shown in FIG. 4, process 400 includes evaluating, using a first layer of an ensemble of judge agents, the chatbot response (block 430). For example, the chat system may evaluate, using a first layer of an ensemble of judge agents, the chatbot response, as described above.

As further shown in FIG. 4, process 400 includes measuring a consensus among the evaluations of the ensemble of judge agents using a differentiator (block 440). For example, the chat system may measure a consensus among the evaluations of the ensemble of judge agents using a differentiator, as described above.

As further shown in FIG. 4, process 400 includes resolving one or more low consensus cases among the evaluations using a second layer of super judge agents (block 450). For example, the chat system may resolve one or more low consensus cases among the evaluations using a second layer of super judge agents, as described above.

As further shown in FIG. 4, process 400 includes determining a final evaluation of the chatbot response based on a consensus technique applied to the evaluations provided by the ensemble of judge agents and the super judge agents (block 460). For example, the chat system may determine a final evaluation of the chatbot response based on a consensus technique applied to the evaluations provided by the ensemble of judge agents and the super judge agents, as described above.

As further shown in FIG. 4, process 400 includes transmitting information associated with the final evaluation of the chatbot response (block 470). For example, the chat system may transmit information associated with the final evaluation of the chatbot response, as described above.

As further shown in FIG. 4, process 400 includes fine-tuning, by the chat system, one or more parameters of the ensemble of judge agents based on determinations made by the super judge agents (block 480). For example, the chat system may fine-tuning, by the chat system, one or more parameters of the ensemble of judge agents based on determinations made by the super judge agents, as described above.

Process 400 may include additional aspects, such as any single aspect or any combination of aspects described below and/or in connection with one or more other processes described elsewhere herein.

In a first aspect, the ensemble of judge agents are powered by a plurality of sets of large language models.

In a second aspect, alone or in combination with the first aspect, the differentiator measures consensus by comparing a variance of judge agent evaluations with respect to a configured threshold.

In a third aspect, alone or in combination with one or more of the first and second aspects, the second layer of super judge agents utilizes pairwise comparisons of judge agent evaluations to resolve the one or more low consensus cases.

In a fourth aspect, alone or in combination with one or more of the first through third aspects, the consensus technique applies a weighted voting scheme to judge agent evaluations.

In a fifth aspect, alone or in combination with one or more of the first through fourth aspects, fine-tuning the ensemble of judge agents utilizes reinforcement learning techniques to align a performance with a set of pre-configured criteria.

In a sixth aspect, alone or in combination with one or more of the first through fifth aspects, process 400 includes augmenting judge agent reasoning with a domain-specific knowledge base.

In a seventh aspect, alone or in combination with one or more of the first through sixth aspects, the chatbot response is evaluated based on an accuracy and an alignment with a set of configured criteria.

In an eighth aspect, alone or in combination with one or more of the first through seventh aspects, the ensemble of judge agents includes at least one large language model judge agent and at least one rule-based analysis algorithm judge agent.

In a ninth aspect, alone or in combination with one or more of the first through eighth aspects, process 400 includes stacking a plurality of layers of judge agents to extract higher-level concepts and features from the chatbot response.

In a tenth aspect, alone or in combination with one or more of the first through ninth aspects, the consensus technique is based on a comparison of the evaluations provided by the ensemble of judge agents and the super judge agents.

In an eleventh aspect, alone or in combination with one or more of the first through tenth aspects, the fine-tuning of the ensemble of judge agents is based on a reinforcement learning mechanism that is based on determinations made by the super judge agents.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:
Aspect 1: A method, comprising: receiving, by a chat system, an input associated with a chatbot; generating, by the chat system, a chatbot response; evaluating, by the chat system and using a first layer of an ensemble of judge agents, the chatbot response; measuring, by the chat system, a consensus among the evaluations of the ensemble of judge agents using a differentiator; resolving, by the chat system, one or more low consensus cases among the evaluations using a second layer of super judge agents; determining, by the chat system, a final evaluation of the chatbot response based on a consensus technique applied to the evaluations provided by the ensemble of judge agents and the super judge agents; transmitting, by the chat system, information associated with the final evaluation of the chatbot response; and fine-tuning, by the chat system, one or more parameters of the ensemble of judge agents based on determinations made by the super judge agents.
Aspect 2: The method of Aspect 1, wherein the ensemble of judge agents are powered by a plurality of sets of large language models.
Aspect 3: The method of any of Aspects 1-2, wherein the differentiator measures consensus by comparing a variance of judge agent evaluations with respect to a configured threshold.
Aspect 4: The method of any of Aspects 1-3, wherein the second layer of super judge agents utilizes pairwise comparisons of judge agent evaluations to resolve the one or more low consensus cases.
Aspect 5: The method of any of Aspects 1-4, wherein the consensus technique applies a weighted voting scheme to judge agent evaluations.
Aspect 6: The method of any of Aspects 1-5, wherein fine-tuning the ensemble of judge agents utilizes reinforcement learning techniques to align a performance with a set of pre-configured criteria.
Aspect 7: The method of any of Aspects 1-6, further comprising: augmenting judge agent reasoning with a domain-specific knowledge base.
Aspect 8: The method of any of Aspects 1-7, wherein the chatbot response is evaluated based on an accuracy and an alignment with a set of configured criteria.
Aspect 9: The method of any of Aspects 1-8, wherein the ensemble of judge agents includes at least one large language model judge agent and at least one rule-based analysis algorithm judge agent.
Aspect 10: The method of any of Aspects 1-9, further comprising: stacking a plurality of layers of judge agents to extract higher-level concepts and features from the chatbot response.
Aspect 11: The method of any of Aspects 1-10, wherein the consensus technique is based on a comparison of the evaluations provided by the ensemble of judge agents and the super judge agents.
Aspect 12: The method of any of Aspects 1-11, wherein the fine-tuning of the ensemble of judge agents is based on a reinforcement learning mechanism that is based on determinations made by the super judge agents.
Aspect 13: A computer system, comprising: a processor set; one or more computer-readable storage media; and program instructions stored on the one or more computer-readable storage media to cause the processor set to perform operations comprising: evaluating chatbot responses using a first layer of an ensemble of judge agents powered by a plurality of types of large language models; measuring consensus among judge agent assessments using a differentiator; resolving low consensus cases with a second layer of super judge agents; determining a final evaluation of the chatbot response based on a consensus mechanism applied to judge agent assessments; and fine-tuning the ensemble of judge agents based on super judge determinations and a set of configured tuning criteria.
Aspect 14: The computer system of Aspect 13, wherein the differentiator measures consensus by comparing a variance of judge agent assessments against a configured threshold.
Aspect 15: The computer system of any of Aspects 13-14, wherein the consensus mechanism applies a weighted voting scheme to judge agent assessments.
Aspect 16: The computer system of any of Aspects 13-15, wherein the fine-tuning utilizes reinforcement learning techniques to align judge agent performance with the set of configured tuning criteria.
Aspect 17: The computer system of any of Aspects 13-16, further comprising: augmenting judge agent reasoning with a domain-specific knowledge base.
Aspect 18: A computer program product, comprising: one or more computer-readable storage media; and program instructions stored on the one or more computer-readable storage media to perform operations, comprising: assessing, by a multi-layer architecture of judge agents of a system, a chatbot response to evaluate the performance of the chatbot; determining, by a differentiator of the system, a level of consensus among assessments from a first layer of judge agents in the multi-layer architecture; resolving, by a second layer of super judge agents in the multi-layer architecture of the system, low consensus cases from the first layer of judge agents; determining, by a consensus mechanism of the system, a final evaluation based on assessments from the second layer of super judge agents; and fine-tuning, by a compliance improvement module of the system, specific judge agents based on determinations from the second layer of super judge agents and compliance criteria.
Aspect 19: The computer program product of Aspect 18, wherein assessments from judge agents are based on pairwise comparisons of chatbot responses and semantic meanings of the chatbot responses.
Aspect 20: The computer program product of any of Aspects 18-19, wherein the fine-tuning of the ensemble of judge agents includes using reinforcement learning techniques to adjust judge agent parameters based on the determinations from the second layer of super judge agents.
Aspect 21: A system configured to perform one or more operations recited in one or more of Aspects 1-20.
Aspect 22: An apparatus comprising means for performing one or more operations recited in one or more of Aspects 1-20.
Aspect 23: A non-transitory computer-readable medium storing a set of instructions, the set of instructions comprising one or more instructions that, when executed by a device, cause the device to perform one or more operations recited in one or more of Aspects 1-20.
Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a generative system, an input associated with a generative output;
generating, by the generative system, a generative output response;
evaluating, by the generative system and using a first layer of an ensemble of judge agents, the generative output response;
measuring, by the generative system, a consensus among the evaluations of the ensemble of judge agents using a differentiator;
resolving, by the generative system, one or more low consensus cases among the evaluations using a second layer of super judge agents;
determining, by the generative system, a final evaluation of the generative output response based on a consensus technique applied to the evaluations provided by the ensemble of judge agents and the super judge agents;
transmitting, by the generative system, information associated with the final evaluation of the generative output response; and
fine-tuning, by the generative system, one or more parameters of the ensemble of judge agents based on determinations made by the super judge agents.

2. The method of claim 1, wherein the ensemble of judge agents are powered by a plurality of sets of large language models.

3. The method of claim 1, wherein the differentiator measures consensus by comparing a variance of judge agent evaluations with respect to a configured threshold.

4. The method of claim 1, wherein the second layer of super judge agents utilizes pairwise comparisons of judge agent evaluations to resolve the one or more low consensus cases.

5. The method of claim 1, wherein the consensus technique applies a weighted voting scheme to judge agent evaluations.

6. The method of claim 1, wherein fine-tuning the ensemble of judge agents utilizes reinforcement learning techniques to align a performance with a set of pre-configured criteria.

7. The method of claim 1, further comprising:
augmenting judge agent reasoning with a domain-specific knowledge base.

8. The method of claim 1, wherein the generative output response is evaluated based on an accuracy and an alignment with a set of configured criteria.

9. The method of claim 1, wherein the ensemble of judge agents includes at least one of:
a large language model judge agent, or
a rule-based analysis algorithm judge agent.

10. The method of claim 1, further comprising:
stacking a plurality of layers of judge agents to extract higher-level concepts and features from the generative output response.

11. The method of claim 1, wherein the consensus technique is based on a comparison of the evaluations provided by the ensemble of judge agents and the super judge agents.

12. The method of claim 1, wherein the fine-tuning of the ensemble of judge agents is based on a reinforcement learning mechanism that is based on determinations made by the super judge agents.

13. A computer system, comprising:
a processor set;
one or more computer-readable storage media; and
program instructions stored on the one or more computer-readable storage media to cause the processor set to perform operations comprising:
evaluating chatbot responses using a first layer of an ensemble of judge agents powered by a plurality of types of large language models;
measuring consensus among judge agent assessments using a differentiator;
resolving low consensus cases with a second layer of super judge agents;
determining a final evaluation of the chatbot response based on a consensus mechanism applied to judge agent assessments; and
fine-tuning the ensemble of judge agents based on super judge determinations and a set of configured tuning criteria.

14. The computer system of claim 13, wherein the differentiator measures consensus by comparing a variance of judge agent assessments against a configured threshold.

15. The computer system of claim 13, wherein the consensus mechanism applies a weighted voting scheme to judge agent assessments.

16. The computer system of claim 13, wherein the fine-tuning utilizes reinforcement learning techniques to align judge agent performance with the set of configured tuning criteria.

17. The computer system of claim 13, further comprising:
augmenting judge agent reasoning with a domain-specific knowledge base.

18. A computer program product, comprising:
one or more computer-readable storage media; and
program instructions stored on the one or more computer-readable storage media to perform operations, comprising:
assessing, by a multi-layer architecture of judge agents of a system, a chatbot response to evaluate the performance of the chatbot;
determining, by a differentiator of the system, a level of consensus among assessments from a first layer of judge agents in the multi-layer architecture;
resolving, by a second layer of super judge agents in the multi-layer architecture of the system, low consensus cases from the first layer of judge agents;
determining, by a consensus mechanism of the system, a final evaluation based on assessments from the second layer of super judge agents; and
fine-tuning, by a compliance improvement module of the system, specific judge agents based on determinations from the second layer of super judge agents and compliance criteria.

19. The computer program product of claim 18, wherein assessments from judge agents are based on pairwise comparisons of chatbot responses and semantic meanings of the chatbot responses.

20. The computer program product of claim 18, wherein the level of consensus among assessments from the first layer of judge agents is measured based on semantic similarity in reasoning traces.
